(19) United States
(12) Patent Application Publication
(10) Pub. No.: US 2010/0110693 A1
(43) Pub. Date: May 6, 2010

(54) LIGHT FIXTURE

(76) Inventor: Matthias BREMERICH, Lennestadt (DE)

Correspondence Address: K.F. ROSS P.C., 5683 RIVERDALE AVENUE, SUITE 203 BOX 900, BRONX, NY, 10471-0900, US

(21) Appl. No.: 12/567,866

(22) Filed: Sep. 28, 2009

(30) Foreign Application Priority Data
Nov. 6, 2008 (DE) 102008056103.7

(51) Int. Cl. F21V 7/00

(52) U.S. Cl. 362/296.01

(57) ABSTRACT

The invention describes and shows a light fixture (10) for illuminating building surfaces (13), comprising a dished reflector (16), in the interior (46) of which a light source (17) can be arranged. The distinctiveness is characterized in that an inner surface (30) of the reflector has at least one first sector (25) and a second sector (27), wherein a major portion of light (29a) coming from the light source and impinging on the first sector (25) is reflected from the first sector onto the building surface, and wherein at least a substantial portion of the light (28a) coming from the light source (17) and impinging on the second sector (27) falls on the building surface (27c) only after a further reflection off the first sector (25).

The invention relates to a light fixture according to the introductory clause of claim 1.

Such light fixtures are known and have been developed and produced by the applicant for some time. They serve for illuminating building surfaces. These are, for example, floor, wall, or ceiling surfaces of a building, but also surfaces outside a building, such as parking areas, landscaping, or paths. Paintings and art objects to be illuminated are also included in the building surfaces according to claim 1.

Light fixtures of conventional construction comprise at least one light source, a so-called illumination means, which is mounted inside an essentially bowl-shaped reflector. Starting from the light source, direct light is reflected from the illumination means onto the building surface in the light fixtures according to prior art, and indirect light is reflected on facets of an inner surface of the reflector onto the building surface.

In certain applications it is desirable to generate on the building surface a light distribution that is asymmetrical with regard to its shape and/or with regard to the distribution of intensity. It may also or optionally be desired to generate a light distribution that deviates from the shape of the edge of the reflector, or from the shape of the edge of a light output opening of the light fixture with regard to the shape of the fixture's reflector.

A rotationally asymmetrical light distribution means according to the invention particularly a light distribution that, relative to a longitudinal center axis of a reflector being formed in an essentially rotations-symmetrical manner, has no rotational symmetry.

In case of a rotationally asymmetrical reflector that is also within the scope of the invention, such as an axially elongated reflector, rotationally asymmetrical light distribution means according to the present patent application particularly, for example, also a light distribution curve that deviates from the shape of the edge of the reflector with regard to the shape thereof. Finally, a rotationally asymmetrical light distribution also means one that has one or more focal points such that a rotationally asymmetrical distribution of intensity is the result.

The object of the invention is to provide a light fixture that allows the generation of focal points in the light distribution onto the building surface and/or that enables the generation of rotationally asymmetrical light distributions to a currently unequaled degree.

The invention solves the problem by means of the characteristics of claim 1, and is therefore characterized in that an inner surface of the reflector has at least one first sector and a second sector, wherein a major portion of light coming from the light source and impinging on the first sector is reflected from the first sector onto the building surface, and wherein at least a substantial portion of the light coming from the light source and impinging on the second sector falls on the building surface reflection off the first sector.

The principle of the invention is therefore essentially that the reflector is made in a modified manner as opposed to the prior art, and the interior of the reflector is subdivided into different sectors at a spacing from each other with different reflection characteristics. For this purpose at least one first sector and one second sector are provided.

A sector in terms of the present patent application is any contiguous surface or grouped together region of the inner surface of the reflector that makes up a substantial part of the total area of the reflector and overall performs a general light-deflecting function. In particular the first sector and the second sector each comprise an area of at least one percent of the total inner surface of the reflector. Advantageously, the first sector and the second sector each comprise a rectified area of at least three percent of the total inner surface of the reflector, further advantageously at least 5%, further advantageously at least 10%, further advantageously at least 15%, and further advantageously at least 20%.

The inner surface of the reflector in particular is made in one piece with a first sector that deflects that light coming from the light source and directly impinging the first sector directly onto the building surface. The reflector comprises a second sector on its inner surface that has a surface that is formed differently from the first sector. The light coming from the light source and impinging on the second sector is initially reflected off that location and is bounced back to the first sector by reflection. These light portions impinge on the building surface only after further reflection off the first sector.

The light fixture according to the invention enables the deflection of portions of the light emitted by the light source at certain angles that were previously not reachable by the light fixture or have not been able to be illuminated with light to a desired degree. In this manner those light portions impinging on the second sector may now be deflected at steep angles due to a further reflection off the first sector, which were previously not reachable by means of an indirect reflection of the light portions on the second sector.

It is therefore possible with the light fixture according to the invention to deflect light portions from the first sector at an angle such that these light portions comprise both light portions coming from the light source and reaching the angle after only one reflection off the first sector and also light portions being subjected to a first reflection off the second sector, and a second reflection off the first sector. Therefore the reflector of the light fixture according to the invention may deflect a greater beam of light at pivot angle than the light fixture according to the prior art.

The inner surface of the reflector may be formed with a plurality of segments having individually formed surfaces. For this purpose the segments in the first sector may be formed with different shapes than the segments of the second sector. Preferably, the entire inner surface of the reflector is occupied by segments. The segments may be formed in the form of facets, and may have an arcuate or protruding surface toward the interior of the reflector. In particular the surface of each segment is arcuate at least once, optionally also twice. In this manner cylindrical shape may in particular be used in the second sector.

The segments in the first sector may also be equipped with planar reflection surfaces.

The remaining sectors of the inner surface of the reflector, which are not part of the first or the second sectors, may also be occupied by facets.

The previously mentioned facets or segments are made in the shape of pillows, and are advantageously provided on the inner surface of the reflector according to a uniform structural array. The structure may comprise rows particularly extending angularly, and columns extending crosswise thereto. Preferably, the segments are arrayed in concentric circular rings.

Relative to the angular direction of the reflector, the first sector and the second sector are spaced from one another. The invention preferably provides that the first sector and the second sector are positioned opposite of each other. Further, both sectors are advantageously positioned opposite of each other at about 180°.

In other words, a geometric arrangement is provided such that the first sector is on a first side of the illumination means, and the second sector is on a second side opposite of the side of the illumination means.

In one embodiment of the invention multiple first sectors and multiple second sectors may be provided. Those light portions coming directly from the illumination means and impinging on one of the multiple second sectors are each reflected coming from there onto a first opposite sector. From there the light is emitted onto the building surface.

The double reflection of the light portions described is preferably carried out such that those light portions emitted onto regions of the second sector or onto one of multiple second sectors coming from the illumination means are reflected back by it onto the first sector or onto one of the multiple first sectors. The reflected-back light portion may particularly cut the longitudinal center axis of the reflector, or extend in direct proximity of the longitudinal center axis.

According to an advantageous embodiment of the invention the first sector is formed contiguously. This means that a substantial circumferential angular sector of the inner surface of the reflector is formed from, for example, between 5° and 180° such that it reflects the light portions coming directly from the light source impinging on it out onto the building surface. Those light portions impinging on it from the second sector are reflected onto the building surface by the first sector.

The formulation according to which the first sector is formed contiguously means in the case of a provision of the inner surface of the reflector with a plurality of individual facets that the facets are provided right next to each other.

The formulation according to which a sector of the inner surface of the reflector is formed contiguously means that the sector may be surrounded by a closed edge or shape. To this end, the interior of the surface surrounded by the shape makes up a substantial portion of the inner surface of the reflector, i.e. a portion of the total surface of the reflector of more than one percent.

According to a further advantageous embodiment of the invention the second sector is also contiguous.

The invention further advantageously provides that the light coming from the light source and impinging on the first sector is essentially deflected onto the building surface completely by the first sector. In this embodiment of the invention the efficiency of the light fixture is very high, i.e. any losses of light beams are kept low. Nearly the entire light coming directly from the light source and impinging on the first sector is directly deflected onto the building surface.

According to a further advantageous embodiment of the invention the major portion of light coming from the light source and impinging on the second sector impinges on the building surface only due to a further reflection off the first sector. In this embodiment of the invention it becomes obvious that substantial light portions, i.e. beyond a random range, are reflected toward the substantial, i.e. palpable, projections of a total beam of light to be deflected into a certain pivot angle from the second sector onto the first sector before they impinge on the building surface.

Advantageously the light fixture is mounted in a locally fixed manner. This use as a building light. Furthermore, the reflector is advantageously mounted in the housing. This enables the use of known configurations.

It is further advantageous that the reflector is centered on a longitudinal center axis essentially in a rotation-symmetrical manner with regard to its basic shape. The longitudinal center axis of the reflector is the axis positioned perpendicular to a light output opening of the reflector.

This enables particularly the production of a reflector for the light fixture according to the invention by means of plastic punch deformation of an aluminum blank. Such a production process is described, for example, in German patent application DE 10 2007 035 528.0 [US 2009/0034271] by the applicant. The content of disclosure of the above cited patent application is included in the content of the present patent application herein, also for reference purposes with regard to individual features.

The longitudinal center axis of the reflector in the sense of the present invention corresponds to the pivoting axis of the blank during the production process, based on the production process of the reflector by means of a pushing action of an aluminum blank.

It should be noted that in addition to a production of the reflector made from aluminum it is also possible to form the reflector as a plastic die cast component, and to subsequently equip it with a reflecting inner surface, such as by means of vapor coating.

Advantageously the invention further provides that the reflecting inner surface of the reflector is shaped such that the light distribution generated from the light fixture is configured in an asymmetrical manner relative to the longitudinal center axis of the reflector. This means that with an arrangement of a reflector being shaped essentially in a rotation-symmetrical manner based on the configuration thereof, which also has a circular light output opening, a light distribution is generated that deviates from a rotational symmetry relative to the longitudinal center axis with regard to the shape thereof and/or with regard to the distribution of intensity thereof and/or optionally also with regard to the position thereof.

According to a further advantageous embodiment of the invention the inner surface of the reflector is occupied by a is plurality of segments in a rotationally asymmetrical arrangement. This enables the embodiment of a light fixture according to the invention for achieving a rotationally asymmetrical light distribution using a reflector that is rotation-symmetrical with regard to the configuration thereof. A desired light distribution may be achieved only by means of the special arrangement of the plurality of segments, which are preferably arrayed on a grid, and by means of the calculated shape of the arches of the surfaces, or by positioning and aligning planar reflection surfaces of the segments.

Also advantageously the inner surface of the reflector is occupied completely by segments shaped like facets. This enables the achieving of low illumination densities on the surface of the reflector such that any glare can be kept at a minimum for the viewer of the reflector.

The invention further advantageously provides that segments of a first type are provided in the first sector and segments of a second type are provided in the second sector. The segments of a second type are formed differently from the segments of the first type. Advantageously, the segments of a second type in the second sector are formed by cylindrical facets. Such facets are described, for example, in the German patent application DE 10 2007 035 396.2 [US 2009/0034272] by the applicant. The content of the patent application is included in the content of the present patent application in order to avoid repetition, but also for reference purposes of the individual features.

According to a further advantageous embodiment of the invention segments having planar surfaces are provided in the first sector. At this location segments are therefore provided that have a planar surface. In this manner the portions of light beams may be reflected at the respective angles in the desired and in a particularly advantageous and optimized manner.

The invention further advantageously provides that the light fixture is embodied as a pole-mounted light fixture. Accordingly, the light fixture comprises a long pole at whose upper end the reflector is mounted. Such a pole-mounted light fixture serves for illuminating exterior surfaces in a particularly advantageous manner, such as parking surfaces.

As an alternative the invention also provides that the light fixture according to the invention is embodied as a down light. In this manner certain ground or wall surfaces of a building may be washed with light in a particularly advantageous manner.

Finally, an alternative embodiment of the invention provides that the light fixture according to the invention is a spotlight for the purpose of flooding walls with light. To this end, it may be provided in particular that the circular light output opening present in the case of a dished reflector that is made rotational-symmetric with regard to the base shape thereof, is aligned along a plane that is not aligned parallel to the ceiling. Therefore, a side wall of a building, for example adjacent to the light fixture, may be homogeneously illuminated in a particularly optimized manner, or if desired, also using focal points.

Further advantages of the invention become obvious from the non-cited sub-claims and with reference to the following description of the illustrated embodiments illustrated in the drawings. Therein:

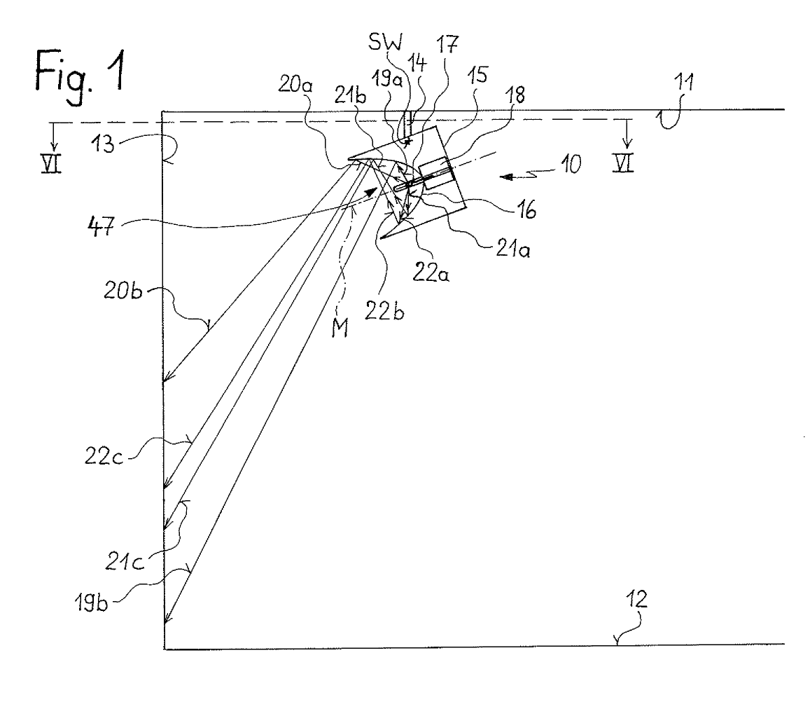

FIG. 1 is a schematic, partially sectored side view of a first embodiment of the light fixture according to the invention, here a spotlight, and mounted on the ceiling for illuminating a wall surface,

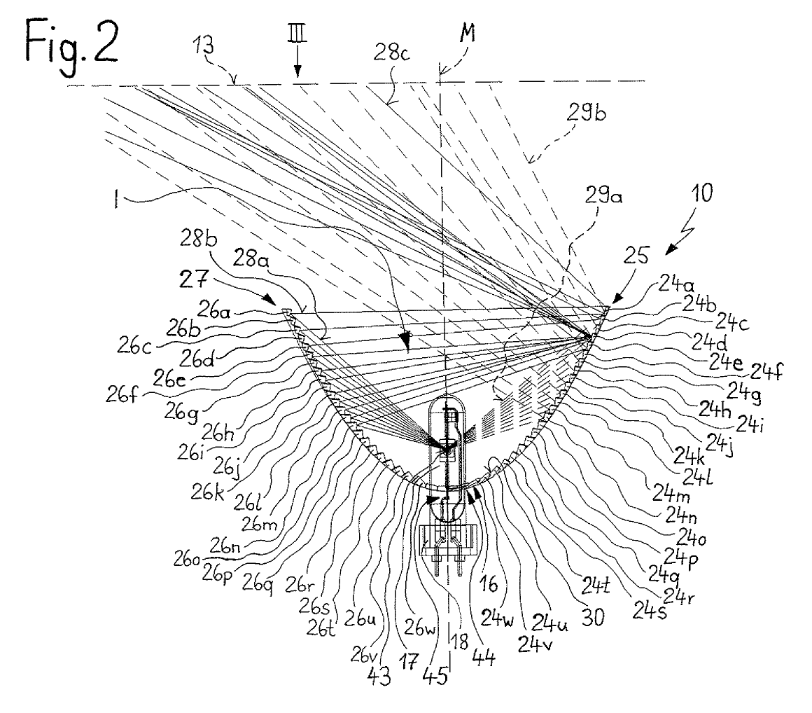

FIG. 2 is an enlarged detail view of a further embodiment of the light fixture according to the invention where the reflector is illustrated in a cross-sectoral view, and where an illumination means engages into an hole at an apex of the reflector,

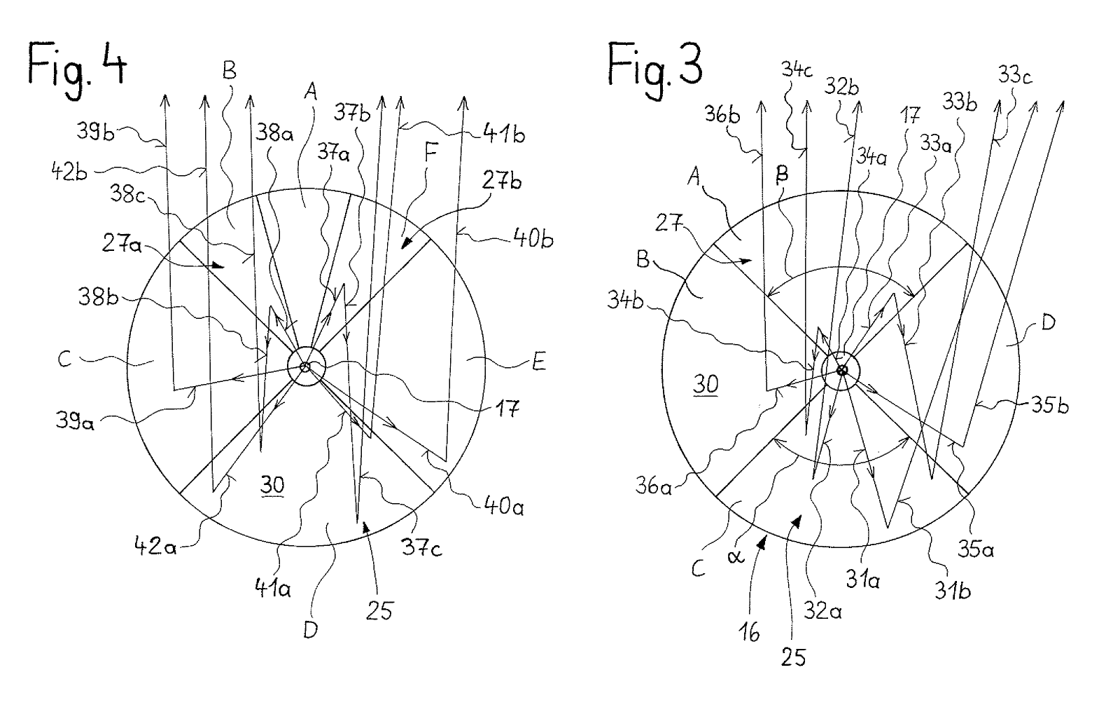

FIG. 3 is a very schematic detail interior view of a further embodiment of a reflector of a light fixture according to the invention approximately corresponding to a view according to the viewing arrow III in FIG. 2,

FIG. 4 is another very schematic view like FIG. 3 of a reflector where there is a different division of the inner surface of the reflector,

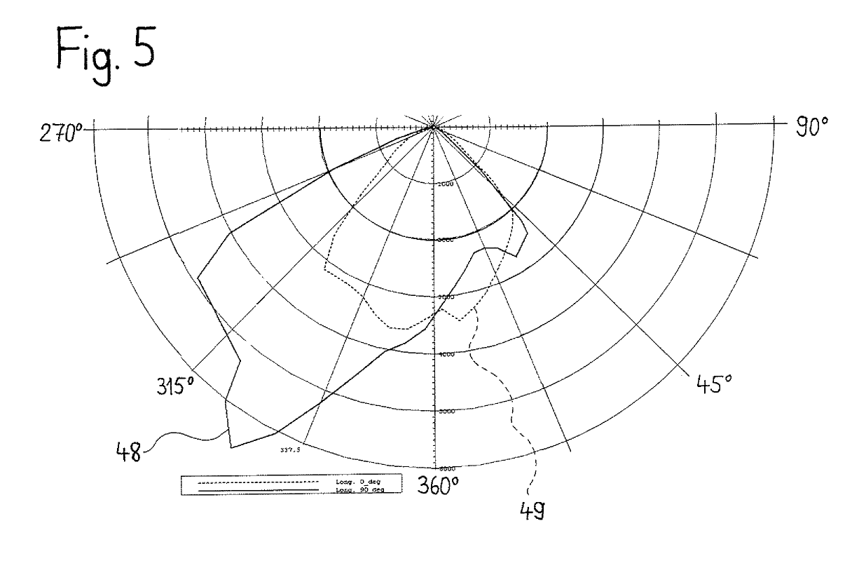

FIG. 5 shows the light distribution of an embodiment of the light fixture according to the invention in a polar coordinate view,

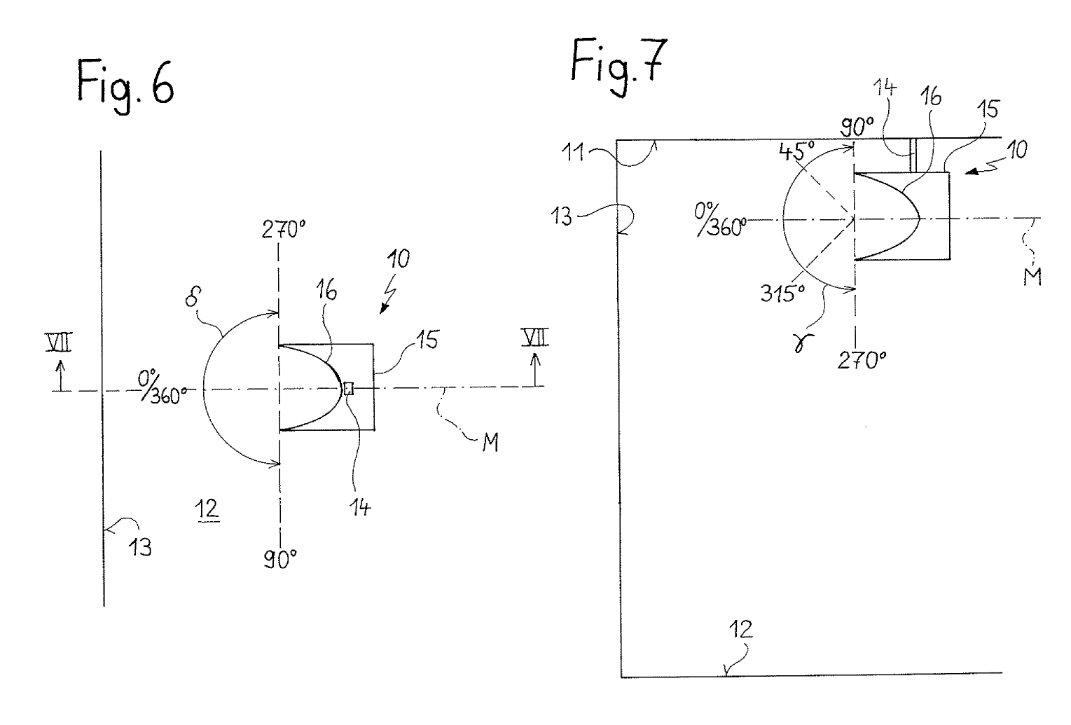

FIG. 6 is a first schematic view showing explaining the dotted curve of in FIG. 5,

FIG. 7 is a further schematic view explaining the curve in FIG. 5 illustrated as a solid line in a view approximately along the intersecting line VII-VII in FIG. 6,

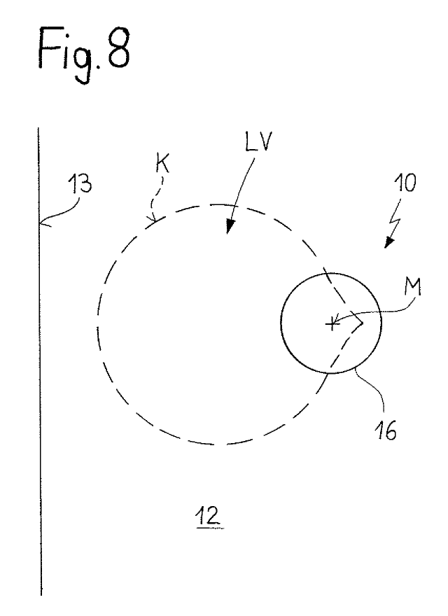

FIG. 8 is a further schematic view explaining a rotationally asymmetrical light distribution, in a view similar to that of FIG. 6, the light fixture 10 of FIG. 8 having been pivoted about a horizontal axis SW through 90° from the light fixture position of FIG. 6,

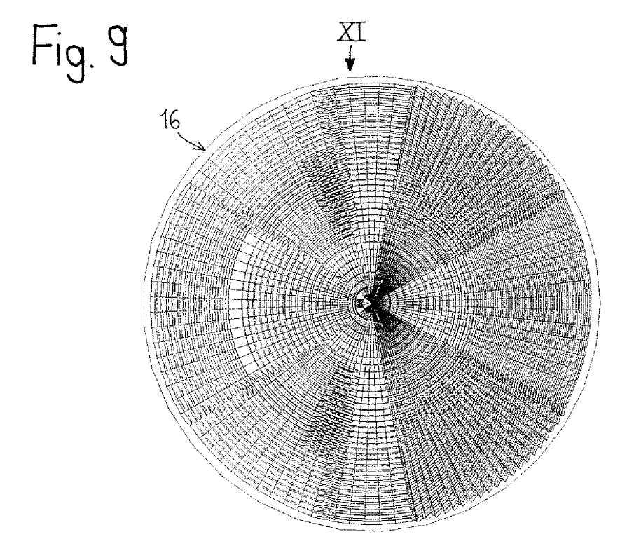

FIG. 9 is a schematic line view of a further embodiment of a reflector of a light fixture according to the invention in an interior view, approximately along the viewing direction of the viewing arrow III in FIG. 2,

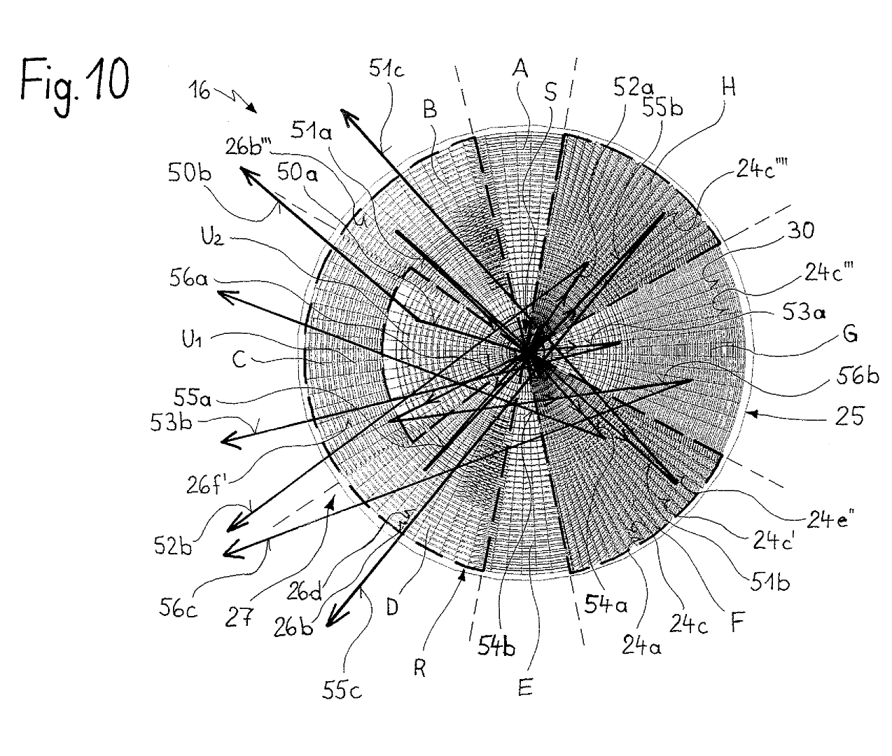

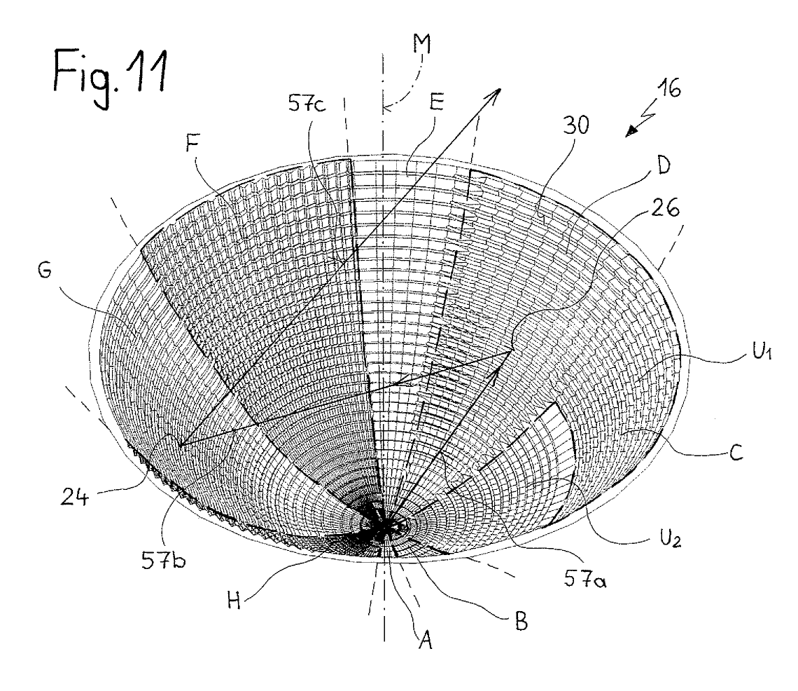

FIG. 10 shows the reflector of FIG. 9 in a view with a plurality of added detail,

FIG. 11 shows the reflector of FIG. 9 in a perspective angular view, approximately according to viewing arrow XI in FIG. 9, and

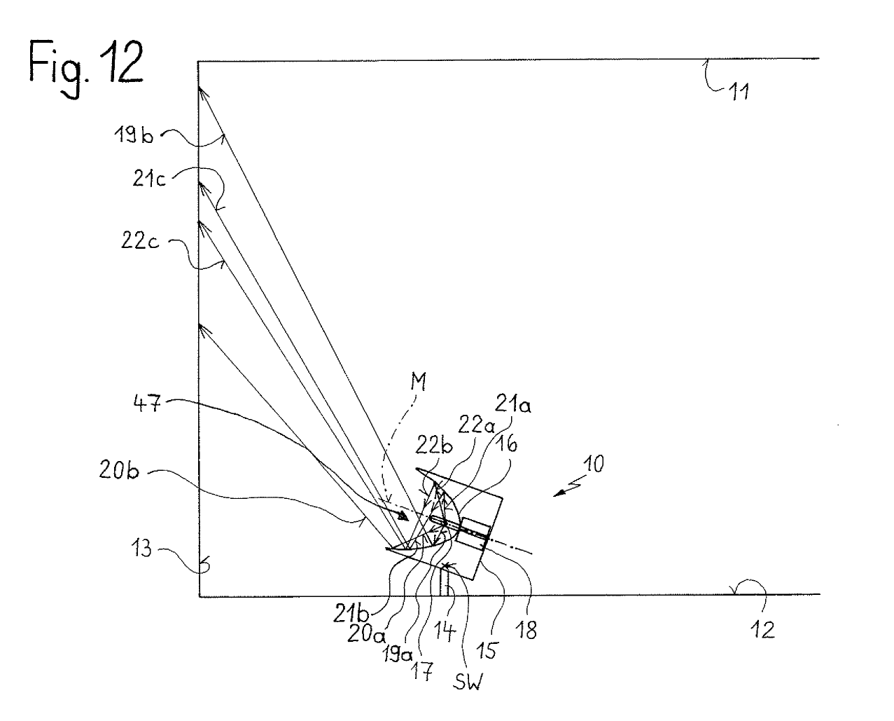

FIG. 12 is a further embodiment of the light fixture according to the invention in a view similar to FIG. 1, where the light fixture is a spotlight mounted on the ground.

The light fixture according to the invention shown generally at 10 in the drawing will now be explained with reference to several embodiments. It should be noted with regard to the following description that identical or similar parts or elements are identified by the same reference symbols for reasons of clarity, adding lower case letters to simplify matters.

FIG. 1 shows in a very schematic, partially sectored side view a first embodiment of a light fixture 10 according to the invention, here a spotlight and mounted on a ceiling 11 of a room of a building. In case of a ceiling mount particularly a side wall 13 may be illuminated in this manner. In case of other not is illustrated embodiments, however, it is also conceivable to illuminate a floor 12, or to illuminate both a side wall 13 and a floor 12.

The light fixture 10 has a housing 15 in which a reflector 16 is completely recessed. The light fixture 10 is suspended from a mount 14 from the ceiling 11 and can pivot about and be locked relative to an axis SW. The light fixture of FIG. 1 is a spot light. However, the invention also comprises other embodiments of light fixtures, such as down lights, which are preferably recessed in a ceiling 11 but can also be pole-mounted light fixtures, with a light fixture is mounted on a support pole in the manner shown in FIG. 1.

FIG. 1 schematically shows a base 18 inside the housing 15 holding a lamp 17, the illumination means. The illumination means 17 extends through a hole 44 at an apex 45 of the reflector 16, and projects into an interior 46 thereof. A plurality of light beams is emitted by the illumination means 17. FIG. 1 shows only by way of example four light beams that clarify the principle according to the invention.

A first light beam 19a is emitted from the illumination means 17, impinges on the reflector 16, in fact on the upper sector thereof as show in FIG. 1, is reflected there, and is cast onto the side wall 13 as a light beam 19b. The same applies to the other light beam 20a that also impinges on the reflector coming directly from the illumination means 17 and is cast onto the side wall 13 as a light beam 20b. This is different for the light beams 21a and 22a. The light beam 21a coming from the illumination means 17 is falls on the lower sector of the reflector 16, is reflected off that location as a light beam 21b, and subsequently impinges again on the upper sector of the reflector 16 with regard to FIG. 1. From there it is cast by the reflector onto the side wall 13 as a light beam 21c.

The same applies to the light beam 22a that is also initially cast onto the lower sector of the reflector 16 by the illumination means 17, is reflected there, and is reflected back onto the upper sector as a light beam 22b, and is cast there against the side wall 13 as a light beam 22c.

This principle is further clarified with reference to the following description of FIG. 2:

FIG. 2 shows the reflector 16 of the light fixture 10 according to the invention in an enlarged detail view. The essentially parabaloid basic shape of the reflector can be seen. The illumination means 17 is mounted with its light-emitting point basically at the focal point 43 of the reflector 16. The illumination means 17 penetrates through the hole 44 at the apex 45 of the reflector.

The reflector has an inner surface 30 that is highly reflective. It should be noted that the reflector is preferably made from pressed aluminum. In order to produce such a reflector, reference can be made, for example, to German patent application DE 10 2007 035 528.0 of the applicant, the content of which is included by reference in the present patent application for the individual features.

The reflector 16 is rotation-symmetrical on its outside, which determines its basic shape. In this regard it is shaped like a bowl centered rotation-symmetrically on a longitudinal axis M.

An array of segments is provided on the inner surface 30 of the reflector 16, like facets and each having an arcuately convex surface turned toward the interior 46 of the reflector 16. In the case of a reflector consisting of aluminum, the segments are pressed from the base material.

The reflector 16 of the light fixture 10 according to the invention has a first sector 25 on the inner surface 30 with segments 24a, 24b, 24c, 24d, 24e, 24f, 24g, 24h, 24j, 24k, 24l, 24m, 24n, 24o, 24p, 24q, 24r, 24s, 24t, 24u, 24v, 24w. A second sector 27 is provided opposite of the sector 25 with other segments 26a, 26b, 26c, 26d, 26e, 26f, 26g, 26h, 26j, 26k, 26i, 26m, 26n, 26o, 26p, 26q, 26r, 26s, 26t, 26u, 26v, 26w.

The segments of the first sector 25 are shaped differently from the segments of the second sector 27; i.e. they have a reflecting surface that is shaped differently.

Starting at the illumination means 27, which is preferably made as a punctiform light source, a plurality of light beams impinge on the segments 24a, 24b, 24c, 24d, 24e, 24f, 24g, 24h, 24j, 24k, 24l, 24m, 24n, 24o, 24p, 24q, 24r, 24s, 24t, 24u, 24v, 24w of the first sector 25, and from there are reflected directly onto the side wall to be illuminated, which is shown as a dotted line in FIG. 2 and indicated at 13. It should be noted that the geometric alignment of the reflector 16 to the side wall 13 is not drawn to scale in FIG. 1, but should be construed merely as a schematic view.

The direct light portions that are subjected to only a single reflection off the first sector 25 will be described below with reference to the light beam 29 taken by way of example. Coming from the illumination means 17 the light beam 29a impinges on the segment 24a of the first sector 25, and is reflected there directly as a light beam portion 29b, and therefore cast directly onto the side-wall surface 13.

The same applies to the remaining light beams of the beam extending from the illumination means 17 in FIG. 2 toward the right.

This is not the case for those light beams that come from the illumination means 17 and impinge on the segments 26a, 26b, 26c, 26d, 26e, 26f, 26g, 26h, 26j, 26k, 26i, 26m, 26n, 26o, 26p, 26q, 26r, 26s, 26t, 26u, 26v, 26w of the second sector 27 of the reflector 16. The path will be clarified by way of example with reference to the light beam 28. From the illumination means 17 the light beam 28 initially falls on the reflecting surface of the segment 26a. From there the light beam does not go out of the reflector 16, but is reflected back toward the first sector 25. In fact, the light beam 28b impinges on the segment 24a of the first sector 25. From there the light beam 28b is reflected onto the side-wall surface 13 as a light beam 28c.

The same is true for the remaining light beams of the ray beam, which, coming from the illumination means 17 in FIG. 2 go to the left.

According to the invention part of the light is reflected twice, namely the portion coming from the illumination means 17 and impinging on the segments 26a, 26b, 26c, 26d, 26e, 26f, 26g, 26h, 26j, 26k, 26i, 26m, 26n, 26o, 26p, 26q, 26r, 26s, 26t, 26u, 26v, 26w then on the segments 24a, 24b, 24c, 24d, 24e, 24f, 24g, 24h, 24j, 24k, 24l, 24m, 24n, 24o, 24p, 24q, 24r, 24s, 24t, 24u, 24v, 24w of the first sector 25, and from there onto the building surface 13 after leaving the reflector 16.

Due to the shape of the inner surface 30 of the reflector 16 according to the invention, the side wall 13 may be impinged with higher light beams in its lower region as shown in FIG. 1. The same applies in a reversed arrangement of the reflector 16 within the housing 15, as shown in FIG. 1, but as an alternative, an upper sector, or a different sector of the side wall 13 of the building may also be more strongly illuminated using the focal points.

As shown in FIG. 3 a clarification follows on how the inner surface 30 of the reflector 16 may be, for example, divided into four angular segments A, B, C, and D.

The first sector 25 may be provided, for example, by the angular segment C, and may extend, for example, over an angle α of about 90°.

The second sector 27 may also extend, for example, over an angle β of about 90°.

FIG. 3 shows that those light beams that impinge the first sector 25 directly from the punctiform illumination means 17 are reflected from there directly toward the exterior, and leave the reflector 16. This applies, for example, to the light beam 31a that leaves the light fixture 10 after reflection off the first sector 25 as a light beam 31b. The same is true for the light beam 32a that leaves the reflector as a light beam 32b after reflection off the first sector 25.

Those light beams that impinge on regions of the second sector 27 from the illumination means 17 are initially reflected there, then cast onto the first sector 25, and only then are reflected from there to the exterior. In this manner the light beam 33a, for example, coming from the illumination means 17, is reflected off the second sector 27, and cast onto the first sector 25 from there as the light beam 33b. From there the light beam leaves the reflector 16 as the light beam 33c only after further reflection. The same applies to the light beam 34a, which, coming from the illumination means 27, is initially reflected off the second sector 27, and is reflected back onto the first sector 25 as the light beam 34b. From there the light beam leaves the reflector 16 as the light beam 24c after further reflection.

The segments B and D of the reflector 16 contribute to the reflection in a conventional manner. The inner surface 30 of the reflector sector serves to cast light beams coming from the illumination means directly toward the exterior. The sectors B and D therefore do not receive any light beams coming from the second sector 27.

For example, the light beam 35a, coming from the illumination means 17, is reflected off the sector D, and leaves the light fixture as the light beam 35b. The same applies to the light beam 36a, which, coming from the illumination means 17, is reflected by the sector B, and leaves the light fixture from there as the light beam 36b.

FIG. 3 shows the inner surface 30 of the reflector 16 of FIG. 2 merely in a schematic view. The viewer should imagine the inner surface 30 of the reflector 16 of FIG. 3 as being covered by a plurality of facets. To this end, for example, similar to the manner in which it was previously described by the applicant in the cited patent application, these may be segments, formed by arcuate surfaces convex toward the interior. However, they may also be any other suitable sectors or bent surfaces of the reflector, regardless of the base shape thereof. For example, the segments may also be embodied in an elongated manner, or in an overlapping manner.

FIGS. 1 to 3 illustrated that the double reflection, for example, enables the obtaining of a preferential light direction. For example, focal points on building surfaces may be obtained, regions of the building surface 13 near or far from the light fixture 10 may be illuminated utilizing a light distribution that is aligned along a preferred direction.

It will be clarified as shown in the embodiment of FIG. 4 that a division of the inner surface 30 of the reflector 16 may also be carried out in a modified manner:

FIG. 4 shows that the inner surface 30 of the reflector may, for example, also be divided into six segments A, B, C, D, E, and F. Here, the segments B and F are constructed to reflect back, that is reflect the light portions coming directly from the light source 17 back onto the segment D.

Segment D is considered the first sector 25 of the inner surface 30 of the reflector 16. Segment B is considered the second sector 27a, and segment F is considered a further second sector 27b in the sense of the present patent application.

Those light portions impinging on the sector 27a, which, coming from the light source 17, impinge on the sector 27a, are reflected from there onto the first sector 25, and leave the reflector only after being reflected therefrom. The same applies to light beams that come from the light source 17 and initially impinge on the sector 27b. This will be described below.

The light beam 38a, coming from the light source 17, initially impinges on the second sector 27a, is then reflected onto the first sector 25 from there, and is reflected out of the light fixture as the light beam 38c.

In this regard FIG. 4 shows that the reflector surface 30 may also be divided into multiple segments. It is important, however, that the first sector 25 and the second sectors 27a, 27b are contiguous, e.g. are surrounded by a common perimetric line, but are spaced from each other.

The remaining light beams 37, 39, 40, 41, and 42 illustrated by arrows correspond to the light beam paths described in FIG. 3 with regard to the meaning and path thereof.

As shown in FIG. 8 it shall now be described that the light fixture 10 according to the invention, serves, for example, for the production of a rotationally asymmetrical light distribution, relative to the longitudinal center axis M of the reflector.

FIG. 8 shows in a very schematic view the light fixture 10 of FIG. 1 viewed toward the ground 12, approximately in a view taken along the partial sector line VI-VI in FIG. 1. To this end, it shall be assumed that the light fixture 10 or the reflector 16 is aligned such that a plane formed by the circular light output surface 47 of the reflector 16 is aligned essentially parallel to the ground 12. The longitudinal center axis M of the reflector 16 is therefore positioned perpendicular to the ground 12. In this case it may be assumed that the side wall 13 does not receive any light. Instead, the entire light emitted by the light fixture is cast onto the ground 12.

The light fixture 10 of FIG. 8 generates a rotationally asymmetrical light distribution LV. The same has any desired shape K, and any desired path of intensity within the surface surrounded by the shape K. A rotationally asymmetrical light distribution in the sense of the present patent application is any light distribution, which has no rotational symmetry relative to the longitudinal center axis M of the reflector 16. The light distribution curve LV of FIG. 8 is such a rotationally asymmetrical light distribution, because it is not rotation-symmetrical relative to the longitudinal center axis M, and extends away, particularly on one side, from the longitudinal center axis M.

As shown in FIGS. 5 to 7 the following shall clarify as to how the light distribution can be concretely measured in a reflector 16 according to FIG. 2.

FIG. 7 shows a very schematic view similar to FIG. 1. Here, one difference to the view of FIG. 1 is that the spotlight 10 has been pivoted clockwise about a pivot axis SW by about 20°, as shown in the view of FIG. 1, e.g. such that the longitudinal center axis M is now positioned essentially perpendicular to the side wall 13.

The arcuate double-headed arrow γ in FIG. 7 shows the 180° pivot angle, toward which the reflector 16 opens. The curve 48 illustrated in the polar coordinate system of FIG. 5 in a solid line shows, as seen in the view of FIG. 7, the path of intensity of the light distribution as a function of the pivot angle γ. To this end, the degree references seen in FIG. 5 have been correspondingly adopted in FIG. 7.

FIG. 6 shows in a very schematic view a light fixture according to the invention in its mounting position of FIG. 1,24 this regard it should be noted, however, that here the reflector 16 is also frontally aligned to the side wall 13 at the light output hole 47 thereof.

The pivot angle δ also corresponds to a 180° angle. Here, a respective angle description is carried out in further conformance to the view of FIG. 5.

FIG. 5 shows in a dotted curve line 49 the path of intensity of the light distribution as a function of the angle δ. The view of FIG. 6 shows that an essentially symmetrical light distribution curve can be achieved relative to the longitudinal center axis M, along the pivot angle δ.

On the other hand the curve 48 of FIG. 5 shows that a preferential direction relative to the pivot angle γ can be achieved with the light fixture 10 according to the invention. The preferential direction becomes possible due to the double reflection according to the invention, and described above.

As shown in the embodiment of FIG. 3 it should be noted that the segments in the first sector 25, have, for example, a particular surface of the first type. The segments provided in the second sector 27 may be equipped with a surface of a second type. For example, the segments of the second sector 27 may be cylindrical segments. They may, as described by the applicant in German patent application DE 10 2007 035 528.0, also be formed with undercuts. A geometry with undercuts is shown in FIG. 2 for the segments 26a, 26b, 26c, 26d, 26e, 26f, 26g, 26h, 26j, 26k, 26l of the second sector 27.

In contrast the segments 24a, 24b, 24c, 24d, 24e, 24f, 24g, 24h, 24j, 24k, 24l, 24m, 24n, 24o, 24p, 24q, 24r, 24s, 24t, 24u, 24v, 24w of the first sector 25 may have a different type of surface. For example, they may be elements having essentially planar reflecting surfaces.

The calculation of the shapes of the individual segments is carried out in extensive computer simulations. Each surface of each individual segment is individually calculated in order to be able to generate an overall optimized light distribution curve LV.

The description of the embodiments as shown in the drawings should be construed merely by way of example. They serve to clarify that major light portions impinging directly onto regions of the first sector 25, coming from the light source 17, are reflected from the sector 25 toward the exterior onto the building surface 13.

The major portion of the light portions impinging onto the second sector 27, coming from the illumination means 17, should be reflected onto the sectors of the first sector 25, and leave the light fixture from there only after further reflection.

Finally, a further embodiment of a reflector 16 of a light fixture 10 according to the invention will be explained as shown in the views of FIGS. 9 to 11:

FIG. 9 shows the interior of the reflector 16, the illumination means not being illustrated for reasons of simplicity. It can be seen that the inner surface 30 of the reflector 16 is divided into a plurality of segments arrayed in a structured manner. The individual segments have individually calculated and configured surfaces.

As obvious from FIGS. 9 and 10, the inner surface 30 of the reflector, basically shaped rotation-symmetrical about the longitudinal center axis M, is divided into a plurality of angular spaced sectors A, B, C, D, E, F, G, H. The individual sectors have different light-technical functions.

Of particular importance is the fact that with the exception of the sector C, all sectors A, B, D, E, F, G, H have an equal or comparable light-technical function along their entire sector extending from the free outer edge R of the reflector 16 to the central apex S.

The sector C on the other hand, can be divided into a sector U₁ that is close to the outer edge, and into a sector U₂ that is close to the apex. Both sectors U1 and U2 have different light-technical functions.

In the reflector of FIGS. 9 to 11 the sectors A, U₂, E, F, G, and H are shaped to deflect those light portions, which are coming from the not illustrated illumination means 17 and impinging on the respective segment surfaces, directly onto the building surface not illustrated in FIG. 10, and to also ensure that a major portion of the respective light beams leave the reflector 16 directly, without any further reflection at the reflector 16.

The sectors B, U₁, and D, however, are formed as back-reflectors. This means that the light coming from the illumination means hitting the sectors B, U1, and D is initially reflected onto other sectors of the reflector and is then cast onto the building surface only after such further reflection.

The light beam paths illustrated by way of example in FIG. 10 shows that those light portions impinging on one of the sectors B, U₁, and D, are each reflected from there at a sector of the reflector that is positioned angularly opposite by exactly 180°, and leave the light fixture only after the second reflection. The back-reflection advantageously occurs along a straight line that which cuts the longitudinal center axis M of the reflector, or extends directly adjacent thereto.

Those segments in the sectors F and H are equipped with level, e.g. planar faces. As in FIG. 2 some of the segments are denoted by reference symbols 224, partially while adding lower case letters, and partially while adding one or more apostrophes.

Those segments in the sectors B, U₁, and D, are denoted with the reference symbol 26 by way of example and in cohesion with the nomenclature in FIG. 2, partially while adding lower case letters and one or more apostrophes.

Those segments (such as segment 24c′″) in the sectors G, are embodied in a cylindrical manner, e.g. they have an essentially cylindrically arcuate surface. Segments in the sectors A, B, U₁, U₂, D, and E, also have cylindrically arcuate surfaces.

FIG. 10 shows that the sectors B, U1, and D mutually form a cohesive, back-reflecting second sector 27 in the sense of the present patent application. Likewise the segments of the sectors

F, G, and H form a reflecting sector 25 overall in the sense of the present patent application.

The second sector 27 consists of a plurality of sub-sectors B, U₁, and D. The sector U₂ of the inner surface 30 of the reflector, however, is not part of a second sector in the sense of the present patent application, since light beams leave the reflector 16 from there after only one reflection.

The following describes the principle according to the invention in more detail as shown in the individual light arrows 50 to 56 of FIG. 10:

The light beam 50a impinging directly onto the sector U₂, coming from the not illustrated illumination means, is reflected only once, and emitted out from the reflector 16 as the light beam 50b.

The light beam 51a coming directly from the illumination means, which impinges onto the sector B, is initially reflected from there as the light beam 51b, and impinges onto a segment of the sector F. A further reflection occurs there such that the light beam leaves the reflector as a light arrow 51c.

The light beam 52a, coming from the illumination means, directly impinges on the surface of a segment of the sector H, and is reflected from there directly out from the reflector 16 as the light beam 52b.

According to the schematic view of FIG. 10 the light beam 52b leaves the reflector in a direction toward the left bottom. It should be noted in this context that the directions of the arrows illustrating the light beams as indicated in the drawings are to be construed merely as schematic views. In fact, the surface of the segment being impinged by the light beam 52a will be oriented such that the light beam 52b leaves the reflector 16 of FIG. 10 in a different direction, and extends particularly parallel, or approximately parallel to the light beam 51c.

This also applies to all schematically illustrated light arrows, also for those arrows of FIG. 11 illustrating the light beams.

The viewer of the drawings of the present patent application will understand that the light arrows illustrated are merely meant to clarify the light-technical function of the respective sector of the reflector surface, and should therefore not be construed as showing the exact direction thereof.

Coming from the light source, the light beam 53a impinged on a segment of the sector G, and is reflected out of the reflector as the light beam 53b.

Coming from the illumination means, the light beam 54a impinges on a segment of the sector F, is reflected once, and leaves the reflector as the light beam 54b.

Coming from the illumination means, a light beam 55a impinges on a sector GT of the second sector 27, and is there reflected back onto a segment of the sector H as the light beam 55b due to a first reflection, and is there reflected out from the reflector as the light beam 55c after further reflection.

Coming from the light source, a light beam 56a impinges on a segment of the sector U1, and is there reflected back as the light beam 56b onto the sector G being positioned on the opposite side by 180°, and from there is reflected out from the reflector as the light beam 56c after further reflection.

The light beams of a sector indicated each clarify the light-technical behavior of the sector for all segments of the sector.

FIG. 10 shows that in case a light beam impinges on a segment of one of the sectors B, U₁, or D due to a back-reflection, thus being reflected back on a segment that is positioned opposite by essentially 180°, relative to the longitudinal center axis, and from there is reflected out from the reflector after further reflection.

Finally, reference should be made to FIG. 12, showing a further embodiment of a light fixture 10 according to the invention in a view similar to that in FIG. 1, which is embodied as a spotlight, and is mounted fixedly on the floor 12. The light fixture also serves for illumination of a side wall 13 analog to the view in FIG. 1. However, the light fixture 10 illustrated in FIG. 12 is used to predominantly illuminate upper regions of the side wall.

For reasons of simplicity the reference symbols in FIG. 1 have been utilized in FIG. 12 for another embodiment.

For reasons of completeness it should be noted that the reflector 16 of the light fixture of FIG. 12, as shown in the position of FIG. 1, is mounted in a manner such that it can pivot about the longitudinal center axis M by 180°.

1. A light fixture for illuminating building surfaces, the fixture comprising a dished reflector in the interior of which a light source can be mounted, characterized in that an inner surface of the reflector has at least one first sector and a second sector, wherein a major portion of light coming from the light source and impinging on the first sector is reflected from the first sector onto the building surface, and wherein at least a substantial portion of the light coming from the light source and impinging on the second sector falls on the building surface only after a further reflection off the first sector.

2. The light fixture according to claim 1, wherein the first sector is contiguous.

3. The light fixture according to claims 1, wherein the second sector is contiguous.

4. The light fixture according to claim 1 wherein light coming from the light source and impinging on the first sector is all deflected from the first sector onto the building surface.

5. The light fixture according to claim 1 wherein the major portion of the light, coming from the light source and impinging on the second sector impinges on the building surface only due to a further reflection off the first sector.

6. The light fixture according to claim 1 wherein the light fixture is mounted in a locally fixed manner.

7. The light fixture according to claim 1 wherein the reflector is mounted in a housing.

8. The light fixture according to claim 1 wherein the reflector is essentially rotation-symmetrical with regard to its basic shape about a longitudinal center axis.

9. The light fixture according to claim 8, wherein the reflecting inner surface of the reflector is made such that the light distribution generated from the light fixture is rotationally asymmetrical relative to the longitudinal center axis of the reflector.

10. The light fixture according to claim 1 wherein the inner surface of the reflector has with a plurality of segments in a rotationally asymmetrical arrangement.

11. The light fixture according to claim 1 wherein the inner surface of the reflector is completely occupied by the segments.

12. The light fixture according to claim 1 wherein segments of a first type are provided in the first sector, and segments of a second type that is different to the first type are provided in the second sector.

13. The light fixture according to claim 1 wherein segments having planar surfaces are provided in the first sector.

14. The light fixture according to claim 1 wherein segments having cylindrically arcuate surfaces are provided in the second sector.

15. The light fixture according to claim 1 wherein the light fixture is embodied as a pole-mounted light fixture.

16. The light fixture according to claim 1 wherein the light fixture is embodied as a down light.

17. The light fixture according to claim 1 wherein the light fixture is embodied as a spotlight for the purpose of flooding a wall with light.
